(19) United States
(12) Patent Application Publication
(10) Pub. No.: US 2026/0229209 A1
(43) Pub. Date: Aug. 6, 2026

(54) SOUND MODELING PASSIVE CIRCUIT FOR ELECTRIC GUITARS, ELECTRIC BASS GUITARS, ELECTRIC-ACOUSTIC GUITARS, AND THE LIKE

(71) Applicant: Sun Yang KIM, Daejeon (KR)

(72) Inventor: Sun Yang KIM, Daejeon (KR)

(21) Appl. No.: 19/632,303

(22) Filed: Mar. 29, 2026

Related U.S. Application Data
(63) Continuation of application No. PCT/KR2024/095059, filed on Jan. 26, 2024.

(30) Foreign Application Priority Data
Nov. 10, 2023 (KR) 10-2023-0155590

(51) Int. Cl. G10H 3/18; G10H 1/00; G10H 1/14; G10H 1/34; G10H 1/46

(52) U.S. Cl. CPC G10H 3/186; G10H 1/0008; G10H 1/14; G10H 1/34; G10H 1/46; G10H 2220/461

(57) ABSTRACT

A sound modeling passive circuit for electric guitars, electric bass guitars, electric-acoustic guitars, or the like includes: a plurality of volume-tone units connected to a pickup installed at one side of saddles to which guitar strings are connected at a front side of a body, the plurality of volume-tone units being configured to adjust tone and volume; an output unit configured to receive a signal output from the plurality of volume-tone units through a signal line and provide the signal through a connection terminal connectable to an external device; and a circuit unit disposed on the signal line and configured such that the signal output from the plurality of volume-tone units sequentially passes therethrough, wherein the circuit unit is selectively actuable by a user to convert the signal or allow the signal to pass.

### CROSS-REFERENCE TO RELATED APPLICATION

This application is a continuation application of PCT International Patent Application No. PCT/KR 2024/095059 filed on Jan. 26, 2024, which claims priority to Korean Patent Application No. 10-2023-0155590 filed on Nov. 10, 2023, which are all hereby incorporated by reference in their entirety.

### BACKGROUND

The present disclosure relates generally to passive sound-control circuitry for stringed electric instruments and, more particularly, to a sound modeling passive circuit for use in electric guitars, electric bass guitars, electric-acoustic guitars, and the like.

In general, an electric guitar is a stringed instrument in which pickups mounted on the guitar convert string vibrations into electrical signals, and the electrical signals are output through an external amplifier and speaker. Electric guitars include various types, such as Strat, Super Strat, Telecaster, Les Paul, Hollow Body, and Mockingbird models, each having distinctive tonal characteristics.

However, tones required in performance or playing environments may vary, and a player may therefore need to carry multiple guitars in order to reproduce desired tones. In such cases, portability is reduced due to increased bulk and weight, and equipment costs are increased.

Accordingly, there is a need for a circuit configuration that allows a user to intuitively select and combine various tonal and timbral blends in a single guitar.

### SUMMARY

An object of the present disclosure is to provide a sound modeling passive circuit for electric guitars, electric bass guitars, electric-acoustic guitars, and the like, which allows users to intuitively create a plurality of tonal characteristics through selective signal conversion, thereby eliminating the need to carry various types of electric guitars.

According to an aspect of the present disclosure, a sound modeling passive circuit for electric guitars, electric bass guitars, electric-acoustic guitars, and the like includes: a plurality of volume-tone units connected to a pickup disposed adjacent to saddles at a front side of a body, the saddles being configured to support strings, the volume-tone units configured to adjust tone and volume; an output unit configured to receive, via a signal line, a signal output from the volume-tone units and to output the signal through a connection terminal configured for connection to an external device; and a circuit unit disposed on the signal line such that the signal output from the volume-tone units sequentially passes therethrough, wherein the circuit unit is selectively actuable by a user to convert the signal or allow the signal to pass.

In addition, the circuit unit may include a plurality of switches arranged sequentially on the signal line such that the signal passes through the switches in sequence, wherein selective actuation of at least one of the switches converts the passing signal, and when the switches are not actuated, the signal is allowed to pass without conversion.

Furthermore, the switches may include capacitors provided with different capacitances in the plurality of switches.

The sound modeling passive circuit for electric guitars, electric bass guitars, electric-acoustic guitars, and the like according to the present disclosure can create various combinations of sounds using the circuit, enabling a single instrument to provide a wider variety of tonal characteristics associated with different types of guitar-family instruments. It has the effect of utilizing the circuit to provide an even wider variety of tonal characteristics.

Therefore, the sound modeling passive circuit according to the present disclosure can create various playing environments, improving convenience because only one guitar needs to be carried. It also has the effect of reducing costs and improving portability since additional electric guitars or other components for changing tonal characteristics are unnecessary.

### BRIEF DESCRIPTION OF THE DRAWINGS

FIG. 1 is a diagram illustrating a sound modeling passive circuit for electric guitars, electric bass guitars, electric-acoustic guitars, and the like according to a first embodiment of the present disclosure.

FIGS. 2 to 5 are diagrams illustrating the operation of the switches of FIG. 1.

FIGS. 6 to 8 are diagrams illustrating the operation of a sound modeling passive circuit for electric guitars, electric bass guitars, electric-acoustic guitars, and the like according to a second embodiment of the present disclosure.

### DETAILED DESCRIPTION

Hereinafter, embodiments of the present disclosure will be described in detail with reference to the accompanying drawings so that those skilled in the art may easily implement the present disclosure. The present disclosure may be embodied in various different forms and is not limited to the embodiments described herein. In the drawings, portions unrelated to the description are omitted for clarity, and like reference numerals designate like or similar elements throughout the specification.

The sizes and thicknesses of elements shown in the drawings are arbitrarily illustrated for convenience of description, and the present disclosure is not necessarily limited to the illustrated dimensions.

In the present disclosure, the expression “on” or “above” a target member means a position located above or below the target member and does not necessarily mean only an upper side with reference to a gravitational direction. Further, when a portion is described as “including” an element, this means that the portion may further include another element unless specifically stated otherwise.

Further, when a portion is described as being “connected” to another portion, this includes not only a case in which it is directly connected but also a case in which it is indirectly connected with another member interposed therebetween.

The present disclosure provides a simple passive circuit control and switching module for an electric guitar that enables generation and selection of a plurality of desired tonal sounds.

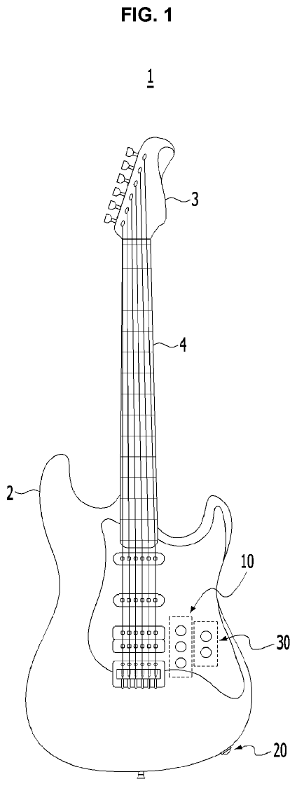

Referring to FIGS. 1 to 5, a sound modeling passive circuit according to a first embodiment includes a plurality of volume-tone units 10, an output unit 20, and a circuit unit 30.

The body 2 forms the main body of an electric guitar 1, and a bridge for fixing steel strings is attached to a front plate of the body 2. The body 2 is provided with a pickup that converts vibrations generated by manipulation of the steel strings into electrical vibrations, that is, audio signals, through a known magnetic induction method. A head 3 provided with a plurality of head machines for adjusting tension of the strings is connected to a neck 4 over which the strings connected to the saddles extend. Since such a configuration is known for a general electric guitar, a detailed description thereof is omitted.

The body 2 may include a power supply terminal for receiving driving power from the outside, the plurality of volume-tone units 10, the output unit 20, and the circuit unit 30.

The plurality of volume-tone units 10 may be connected to a pickup installed at one side of saddles to which guitar strings are connected at a front side of the body 2, and may adjust tone and volume.

The volume-tone units 10 may include at least one of a level unit that adjusts a magnitude of an output signal and a tone unit that adjusts amounts of high-frequency and low-frequency components, and may adjust volume or tone corresponding to the output signal by means of variable resistance.

The output unit 20 is installed in the body 2 and may include a connection terminal for outputting audio generated in the electric guitar 1 to an external amplifier, and an amplifier connection terminal for electrically connecting the electric guitar to an amplifier installed outside.

The output unit 20 may receive, through a signal line, the signal provided from the volume-tone units 10. The output unit 20 may receive either a converted signal that has passed through the circuit unit 30 disposed on the signal line or an original sound signal that has not been processed by the circuit unit 30.

The circuit unit 30 may selectively convert a signal received from the volume-tone units 10 or may provide the original signal to the output unit 20. The circuit unit 30 may determine whether an audio signal generated in the electric guitar is converted or audio-processed by variable resistance and then output, or is output without audio processing.

The circuit unit 30 may be applied to guitars operated by electrical signals and is not necessarily limited to electric guitars, electric bass guitars, and electric-acoustic guitars. For convenience of description, however, the circuit unit 30 is described herein as being provided in an electric guitar.

The circuit unit 30 is disposed on the signal line such that the signal output from the volume-tone units 10 sequentially passes therethrough, and the circuit unit 30 may be selectively actuated by a user to convert the signal or allow the signal to pass and provide the signal to the output unit 20.

The circuit unit 30 may include a plurality of switches 31 and 32 sequentially provided on the signal line such that the signal passes through the switches, respectively. When at least one of the switches 31 and 32 is selectively actuated, the passing signal is converted, and when the switches 31 and 32 are not actuated, the signal is allowed to pass.

The circuit unit 30 may be divided into a passive off state and an active on state. When the circuit unit 30 is placed in the off state, an original sound is selected. When the circuit unit 30 is placed in the on state, audio subjected to conversion processing may be heard.

The switches 31 and 32 may include capacitors 314 and 324 having different capacitances, respectively, thereby converting part of the signal provided from the volume-tone units 10. Further, the switches 31 and 32 may include a first switch 31 and a second switch 32, each including capacitors 314 and 324, inductors 312 and 322, and resistors 313 and 323.

For example, a first capacitor 314 of the first switch 31 may have a capacitance of 68 μF, and a second capacitor 324 of the second switch 32 may have a capacitance of 101 μF. These capacitance values are merely illustrative examples, and various capacitances may be used according to a user's setting to realize various tones.

When a user selectively actuates one or more of the first switch 31 and the second switch 32, the switches 31 and 32 may provide, to the output unit 20, a signal converted according to the actuated switches.

According to the first switch 31 and the second switch 32, a signal may be variously converted according to combinations thereof. For example, when the first switch 31 is on, the second switch 32 may be on or off. When both the first switch 31 and the second switch 32 are on, the signal may be converted by each of the first and second switches.

When the first switch 31 is off, the user may select whether the second switch 32 is on or off. When both the first switch 31 and the second switch 32 are off, an original sound may be provided to the output unit 20. Therefore, various combinations may be implemented according to user settings.

The first switch 31 may include a switch terminal connected to the signal line and configured to be connected or shorted, and a first switch line 311 connected to the switch terminal and including a first inductor 312, a first resistor 313, and a first capacitor 314. When the switch terminal is connected, the signal provided from the volume-tone units 10 is converted by the first inductor 312, the first resistor 313, and the first capacitor 314. When shorted, the signal provided from the volume-tone units 10 passes through the signal line.

The second switch 32 may include a switch terminal connected to the signal line and configured to be connected or shorted, and a second switch line 321 connected to the switch terminal and including a second inductor 322, a second resistor 323, and a second capacitor 324. When the switch terminal is connected, the signal provided from the volume-tone units 10 is converted by the second inductor 322, the second resistor 323, and the second capacitor 324. When shorted, the signal provided from the volume-tone units 10 passes through the signal line.

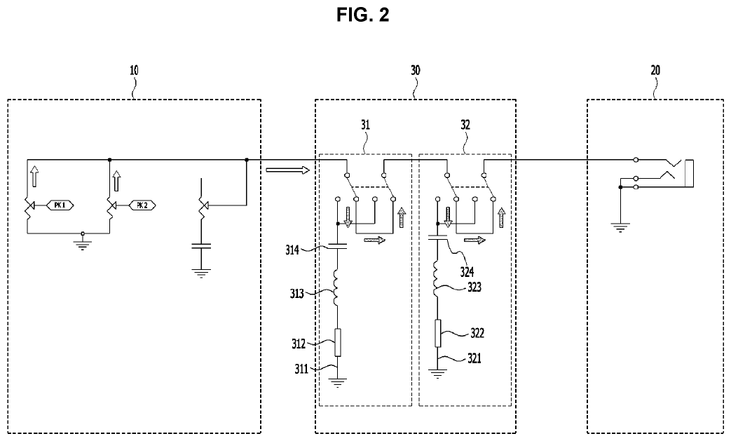

Referring to FIG. 2, when both the first switch 31 and the second switch 32 are set to off, a signal traveling along the signal line passes through the first switch 31 and the second switch 32 and is directly provided from the volume-tone units 10 to the output unit 20, thereby providing an unconverted original sound.

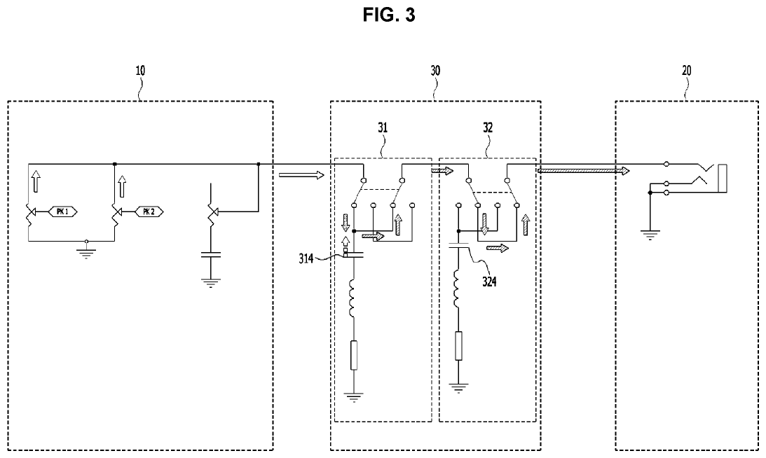

Referring to FIG. 3, when the first switch 31 is turned on and the second switch 32 is set to off, the signal traveling along the signal line is converted as the switch terminal contacts the first switch line 311 and then returns to the signal line. Because the second switch 32 is in the off state, the signal is directly provided to the output unit 20. Accordingly, a converted sound based on the first switch 31 may be provided to the output unit 20.

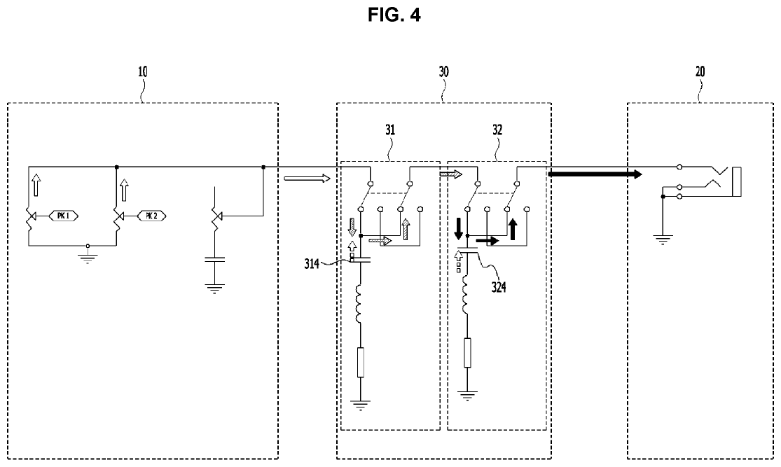

Referring to FIG. 4, when both the first switch 31 and the second switch 32 are set to on, the signal is converted in the first switch 31 and the second switch 32 through the above-described process, returns to the signal line, and is then provided to the output unit 20. Accordingly, a converted sound based on both the first switch 31 and the second switch 32 may be provided to the output unit 20.

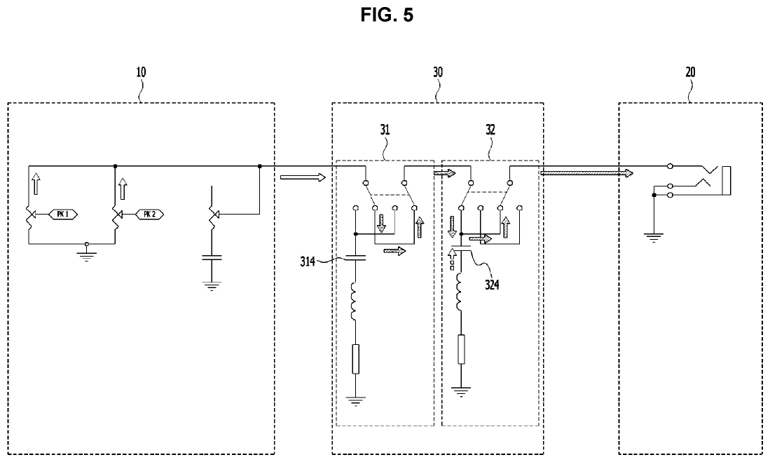

Referring to FIG. 5, when the first switch 31 is set to off and the second switch 32 is set to on, the signal traveling along the signal line passes through the first switch 31 without conversion and is then converted by the second switch 32 before being provided to the output unit 20. Accordingly, a converted sound based on the second switch 32 may be provided to the output unit 20.

According to the sound modeling passive circuit for electric guitars, electric bass guitars, electric-acoustic guitars, and the like of the present disclosure, a user may simply and selectively combine desired signals to provide various tonal characteristics.

Further, more switches may be installed in addition to the above-described switches, thereby providing an even wider variety of tonal characteristics.

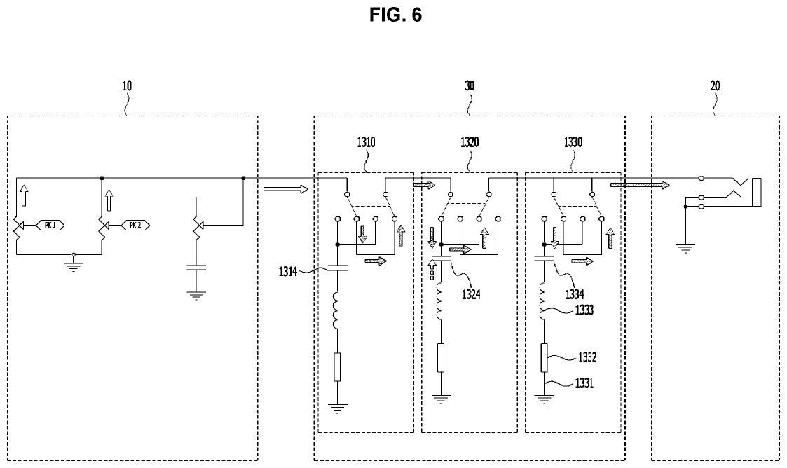

Referring to FIGS. 6 to 8, a second embodiment will now be described. Detailed description of components that are duplicated from the first embodiment is omitted, and only operations according to combinations of additionally provided switches will be described.

A circuit unit 30 of the sound modeling passive circuit according to the second embodiment includes a first switch 1310, a second switch 1320, and a third switch 1330.

The first switch 1310 may include a switch terminal connected to the signal line and configured to be connected or shorted, and a first switch line 1311 including a first inductor 1312, a first resistor 1313, and a first capacitor 1314, such that when the switch terminal is connected, the signal provided from the volume-tone units 10 is converted by the first inductor 1312, the first resistor 1313, and the first capacitor 1314, and when shorted, the signal passes through.

The second switch 1320 may include a switch terminal connected to the signal line and configured to be connected or shorted, and a second switch line 1321 including a second inductor 1322, a second resistor 1323, and a second capacitor 1324, such that when the switch terminal is connected, the signal provided from the volume-tone units 10 is converted by the second inductor 1322, the second resistor 1323, and the second capacitor 1324, and when shorted, the signal passes through.

The third switch 1330 may include a switch terminal connected to the signal line and configured to be connected or shorted, and a third switch line 1331 including a third inductor 1332, a third resistor 1333, and a third capacitor 1334, such that when the switch terminal is connected, the signal provided from the volume-tone units 10 is converted by the third inductor 1332, the third resistor 1333, and the third capacitor 1334, and when shorted, the signal passes through.

According to the first switch 1310, the second switch 1320, and the third switch 1330, more combinations may occur than in the case of two switches, thereby selectively providing various tonal characteristics according to a user's environment.

For example, when the first switch 1310 is in an on state, the second switch 1320 and the third switch 1330 may each be on or off. When the first switch 1310, the second switch 1320, and the third switch 1330 are all on, the signal is sequentially converted, thereby enabling fine adjustment.

Further, when the first switch 1310 is off, operations of the second switch 1320 and the third switch 1330 may be selected independently as on or off. When all of the first switch 1310, the second switch 1320, and the third switch 1330 are off, an original sound may be provided to the output unit 20.

Here, the first switch 1310 to the third switch 1330 may respectively include capacitors 1314, 1324, and 1334 having different capacitances. As described above with respect to the first embodiment, because the capacitors have different capacitances, the signal output from the volume-tone units 10 may be converted according to the capacitor output, and the user may finely convert the signal by adjusting the capacitance of the capacitors to suit a desired environment.

For example, referring to FIG. 6, when the second switch 1320 is on and the first switch 1310 and the third switch 1330 are off, the signal output from the volume-tone units 10 is converted by the second switch 1320. Since the first switch 1310 and the third switch 1330 are off, no further conversion is performed and the signal is provided to the output unit 20.

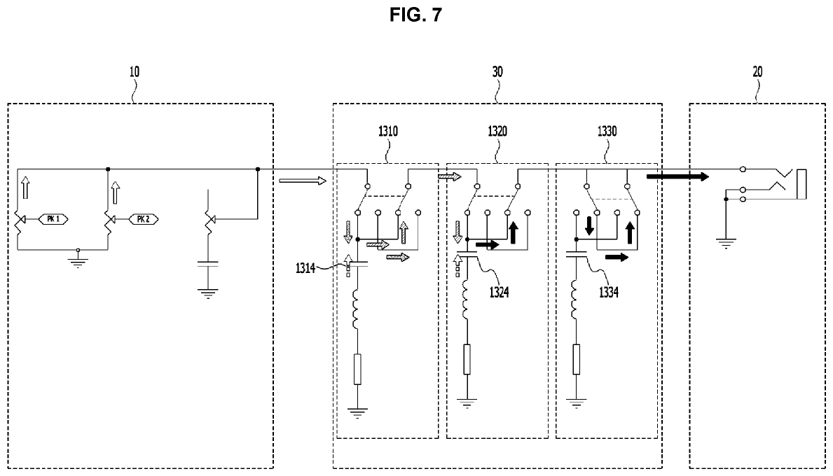

Referring to FIG. 7, when the first switch 1310 and the second switch 1320 are on and the third switch 1330 is off, a signal converted through the first switch 1310 and the second switch 1320 is provided to the output unit 20.

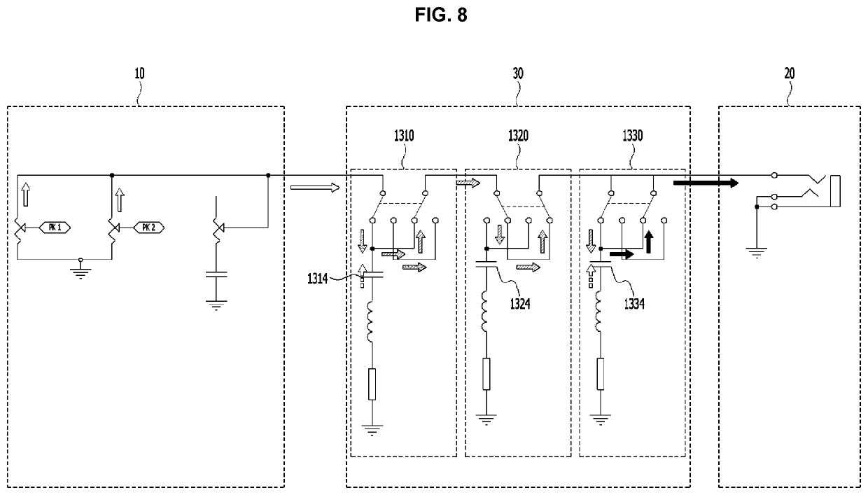

Referring to FIG. 8, when the first switch 1310 and the third switch 1330 are on, or when the second switch 1320 and the third switch 1330 are on, signals converted through the corresponding switches may be provided to the output unit 20.

According to the sound modeling passive circuit for electric guitars, electric bass guitars, electric-acoustic guitars, and the like of the present disclosure, various combinations of sounds may be created so that a single instrument can provide sounds or tonal characteristics corresponding to various guitar-family instruments and configurations. Thus, more diverse tonal characteristics may be created using the circuit. Further, only one instrument needs to be carried even in various playing environments, thereby improving convenience, reducing cost, and improving portability.

The foregoing description of the present disclosure is for illustrative purposes only. Those skilled in the art will understand that the present disclosure may be easily modified in other specific forms without changing the technical spirit or essential features of the present disclosure.

Accordingly, the embodiments described above should be understood as illustrative in all respects and not limiting. For example, each component described as a single type may be implemented in a distributed manner, and similarly, components described as distributed may also be implemented in an integrated form.

The scope of the present disclosure is defined by the appended claims rather than by the foregoing detailed description, and all changes or modifications derived from the meaning and scope of the claims and their equivalents should be construed as being included within the scope of the present disclosure.

Although preferred embodiments of the present disclosure have been described above, the present disclosure is not limited thereto, and various modifications may be made within the scope of the appended claims, the detailed description, and the accompanying drawings, all of which also belong to the scope of the present disclosure.

The present disclosure may be used as a sound modeling passive circuit for electric guitars, electric bass guitars, electric-acoustic guitars, and the like, because it can selectively convert signals to provide a plurality of tonal characteristics and can be intuitively used without the need to carry various types of electric guitars.

What is claimed is:

1. A sound modeling passive circuit for an electrified stringed instrument, the circuit comprising:
a plurality of volume-tone units connected to a pickup disposed adjacent to saddles at a front side of a body, the saddles being configured to support strings, the plurality of volume-tone units being configured to adjust tone and volume;
an output unit configured to receive, via a signal line, a signal output from the plurality of volume-tone units and to output the signal through a connection terminal configured for connection to an external device; and
a circuit unit disposed on the signal line and configured to selectively either convert the signal or allow the signal to pass,
wherein the signal output from the plurality of volume-tone units passes through the circuit unit before being provided to the output unit.

2. The sound modeling passive circuit of claim 1,
wherein the circuit unit comprises a plurality of switches arranged sequentially on the signal line,
wherein the signal passes through the plurality of switches in sequence, and
wherein selective actuation of at least one switch converts the signal, and non-actuation of the plurality of switches allows the signal to pass without conversion.

3. The sound modeling passive circuit of claim 2,
wherein the plurality of switches respectively include capacitors having different capacitances.
